(19) United States
(12) Patent Application Publication
(10) Pub. No.: US 2014/0109762 A1
(43) Pub. Date: Apr. 24, 2014

(54) Control Actuator

(71) Applicant: KARL DUNGS GMBH & CO. KG, Urbach (DE)

(72) Inventor: Lars Bathke, Schorndorf (DE)

(73) Assignee: KARL DUNGS GMBH & CO. KG, Urbach (DE)

(21) Appl. No.: 14/056,379

(22) Filed: Oct. 17, 2013

(30) Foreign Application Priority Data
Oct. 19, 2012 (DE) 10 2012 109 977.4

(51) Int. Cl. F15B 15/20

(52) U.S. Cl. CPC F15B 15/20
USPC 91/418; 92/169.1

(57) ABSTRACT

The control actuator in accordance with the invention comprises a first part with a first wall arrangement and a bottom that circumscribe an inflow volume. The first wall arrangement comprises at least one flow opening through which fluid from the inflow volume can flow. Furthermore, the control actuator comprises a second part with a second wall arrangement that is arranged so as to be adjustable along the first wall arrangement. As a result of this, the fluid flow through a flow opening can be gradually cleared or limited. Preferably, the bottom is arranged in such a manner that the bottom breaks a basic inflow direction Sₑ into the inflow volume and shields the second part against inflow pressure surges.

### BACKGROUND OF THE INVENTION

The subject matter of the invention is a regulating valve for the input independent pressure-independent regulation of an output pressure of fluids, in particular gasses.

Publication DE 40 08 493 A1, for example, discloses double seat regulating valves comprising two closure parts with associate valve seats, wherein the closure parts are connected to each other in order to control an output pressure. The forces acting on the surfaces of the closure parts due to a pressure difference between input pressure and output pressure are equal in amount and oppositely directed, and negate each other due to the communication between the closure parts. Double seat regulating valves of the described type must be manufactured with extreme precision, on the one hand, and absolutely require two passages and thus much space, on the other hand. Due to their design, they feature several gas deflections and thus a relatively high flow resistance.

Web Address:

Furthermore, www.arca.de/download/1/ARCA_SLY_STELLVENTILE_DE.PDF discloses a forging valve (page 4 “with perforated plug”) that is configured as a sliding valve.

Considering this prior art, it is the object of the invention to provide a regulating valve for the input pressure-independent pressure regulation that is input pressure-independent, said regulating valve having a compact design.

### SUMMARY OF THE INVENTION

In accordance with the invention this object is achieved with a regulating valve displaying the features of claim 1.

The regulating valve comprises a first part that comprises a closed base as well as a first wall arrangement with at least one flow-through opening, wherein the base and the wall arrangement delimit an inflow volume. In addition, the regulating valve comprises a second part that is arranged outside the inflow volume and comprises a second wall arrangement with at least two wall sections. The second wall arrangement is arranged so as to be adjustable relative to the first wall arrangement in one adjustment direction in order to gradually open or close the flow opening by means of the wall sections. Preferably, the second wall arrangement can be adjusted parallel along the first wall arrangement. However, the second wall arrangement can be arranged along the first wall arrangement so as to be also (rotationally) adjustable about at least one rotational axis. An actuating drive is connected with the first part in order to move it in or about an adjustment direction. The base and the wall arrangement of the first part delimit an inflow volume and shield sections of the second part that may be referred to as the closure part of the valve in particular against those forces that are generated due to pressure fluctuations of the input pressure or due a pressure surge on the input side. These pressure fluctuations could otherwise lead to an undesirable adjustment motion of the regulating valve.

The base of the first part is essentially closed, however it may also contain pores, micro-openings as well as small recesses. Preferably, these openings have a flow cross-section that is so small and a flow resistance that is such that the input-side pressure surges do not advance into the volume delimited between the first and the second parts.

Sections of the base of the first part may extend into the inflow volume. For example, the base may be round and the first wall arrangement may have a cylindrical basic form. Such a cylindrical wall arrangement and a round base essentially delimit a cylindrical inflow volume. However, the wall arrangement may also have other regular, e.g., cuboid-shaped, or irregular basic forms. The first wall arrangement comprises at least one flow opening through which the fluid may pass from a region having an input pressure into a region having an output pressure. Preferably, a flow opening has a continuous recess in the first wall arrangement, however, it may also have a discontinuous recess in the first wall arrangement. The flow opening may have a round such as, for example, a circular or an elliptical, or a polygonal such as, for example, a rectangular, recess. The flow opening may also have another regularly or irregularly shaped recess. A flow opening may also be an opening in an attached component offset from the first wall arrangement or also through an opening in a part worked out of the first wall arrangement. Furthermore, a flow-through opening may also be closed within itself along or around the entire first wall arrangement. Furthermore, several flow openings may be provided in or on the first wall arrangement.

The at least two wall sections of the second wall arrangement of the second part may be spatially separated, they may be connected by one or more coupling pieces or they may be arranged directly connected next to each other, or the at least two wall sections may be simply imagined sections of a wall. The second wall arrangement may be arranged so as to be adjustable in a vertical adjustment direction parallel to the first wall arrangement or so as to be rotatable about an axis of rotation along the first wall arrangement. Due to the adjustable arrangement of the second wall arrangement and the flow opening in the first wall arrangement, ultimately an adjustable cross-sectional area of flow for the fluid is produced. By adjusting the second wall arrangement in an adjustment direction the cross-sectional area of flow for the fluid can be increased or decreased. By adapting the form and area of one or more flow openings with the second wall arrangement, it is possible to achieve a desired profile of the flow cross-section by means of the adjustment path. With the use of an actuator that is connected to the second part it is possible to adjust the flow cross-section corresponding to the pressure difference.

Preferably, there is at least one adjustment position of the first wall arrangement and the second wall arrangement for which one or more flow openings are closed, i.e., tight. Preferably, the second wall arrangement is arranged so as to be adjustable parallel to the first wall arrangement.

In a preferred embodiment, two wall sections each of the second wall arrangement are connected to each other. The connection may be accomplished directly or via one or more intermediate pieces or other wall sections. Two wall sections of this embodiment that are connected with each other form a wall section pair.

One part of the first wall section and one part of the second wall section of a wall section pair can at least partially cover the flow openings. Such parts may be referred to as delimiting parts of the first and the second wall sections. The output pressure Pₑ exists on one side of such delimiting parts and the input pressure Pₑ exists on the other side.

Preferably, the wall sections of one wall section pair are arranged in such a manner that, firstly, there is a first plane and the projected area of the delimiting part of the first wall section on this first plane is equal to the projected area of the delimiting part of the second wall section on this first plane. “Projected area” is to be understood to mean the area of projection of the respective delimiting part on the first plane.

Preferably, there is, secondly, a second plane that is perpendicular to the first plane so that the projected area of the delimiting part of the first wall section of the wall section pair on this second plane is zero and the projected area of the delimiting part of the second wall section on this second plane is zero.

Preferably, there is, thirdly, an additional third plane that is perpendicular to the first plane and the second plane, so that the projected area of the delimiting part of the first wall section on this third plane is zero, and also the projected area of the delimiting part of the second wall section on this third plane is zero.

Accordingly, the wall sections of a wall section pair are preferably arranged in such a manner that the wall sections exhibit surface vectors facing in opposite directions. A surface vector defines the direction of force on a wall section based on a pressure difference between a pressure Pₑ on one side of the wall and a pressure Pₐ on the other side of the wall. The value of the surface vector multiplied by the pressure difference results in the amount of force on the wall section.

In this manner, the forces on the wall sections of one wall section pair negate one another, and preferably, no resultant force due to a pressure difference between the input pressure Pₑ and the output pressure Pₐ acts on the second wall arrangement.

Preferably, the forces on the wall sections of a wall section pair are negated in one point, so that no torque and no net force due to a pressure difference between the input pressure Pₑ and the output pressure Pₐ can be applied to the second wall arrangement.

Preferably, the wall sections of a wall section pair are arranged in such a manner that the wall sections of the wall section pair are arranged relative to a plane so as to be surface-symmetrical relative to one another.

Preferably, the first part comprises a first wall arrangement that has a hollow cylindrical basic shape. In this manner, it is possible to create an inflow volume that has a cylindrical basic form.

The basic direction of the inflow can be broken by the bottom of the first part. The bottom of the second part may project into the inflow volume. In doing so, the inflow into the inflow volume can be divided into at least two partial flows following different directions. For example, the bottom may be coniform or conical, truncated, pyramidal, gabled or project into the inflow volume in another manner suitable to accomplish a division into partial flows.

In an advantageous embodiment, the bottom comprises at least one flow guiding surface. Due to the flow guiding surface, a fluid stream can be directed at a flow opening. Or, it is also possible, for example, to guide one or more partial flows by means of one or more flow guiding surfaces to different sections of one flow opening or to two flow openings. In this manner, it is also possible to minimize the flow through resistance of the regulating valve.

Preferably, the actuating drive comprises a pressure membrane, wherein the actual pressure Pₐ prevails on one side of the pressure membrane and the set pressure can be prespecified on the other side of the pressure membrane. This can be accomplished, for example, in that the other side of the membrane is subjected to the set pressure. Alternatively, a mechanical force equivalent may be provided, for example, by a spring or a weight. The actuating drive may also comprise a combination of an aneroid capsule and a spring for prespecifying the set pressure. Preferably, the set-point generator is set up so as to be adjustable.

In a preferred embodiment, the control actuator is combined with a closing valve arrangement comprising at least one closing valve. The closing valve may be a sliding valve. Preferably, however, the closing valve is a seat valve. With the aid of the closing valve, it is possible to shut off the inflow volume in a fluid-type manner, at least on the side of the control actuator. In this manner, the fluid flow through the first part and the second part can be preferably stopped completely.

In a preferred embodiment, the closing valve comprises a first valve seat and a first valve closure part, as well as a first seal and a second closure part with a second valve seat, and a second closure part also with a second seal. The closing valve arrangement is set up first, so that the first closing valve is opened when the closing valve arrangement is opened, then a first fluid inflow cross-section is cleared and an inflow into the inflow volume is allowed, and then the second closing valve is opened and a second fluid inflow cross-section into the inflow volume is cleared. Preferably, the closing valve arrangement can be actuated with a single actuating drive.

Advantageous embodiments of the invention can be inferred from the dependent patent claims and the description. Advantageous developments are obtained by the combination of at least one of the dependent claims displaying the features of one or more dependent claims. The drawings are supplementary to the description. The features of FIGS. 1 and 2 can be advantageously combined with one another. The schematic illustrations show in:

Other objects and advantages of the present invention will become apparent to those skilled in the art upon a review of the following detailed description of the preferred embodiments and the accompanying drawings.

### IN THE DRAWINGS

FIG. 1 is a control actuator having a cylindrical inflow volume;

FIG. 2 is a control actuator in an additional embodiment.

It is pointed out that the drawings are not true to scale in order to achieve a better representation.

### DETAILED DESCRIPTION OF THE INVENTION

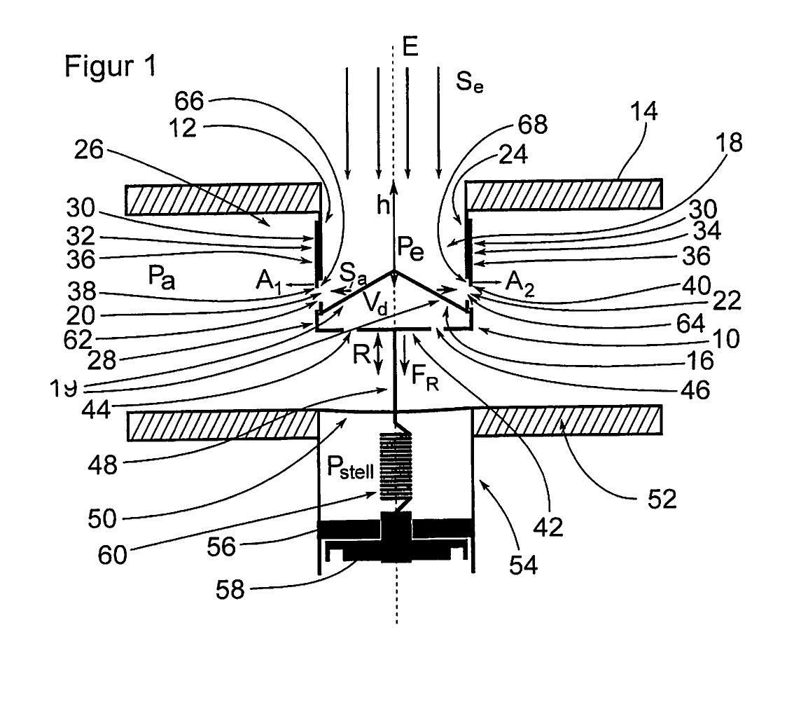

FIG. 1 shows a cross-section through a control actuator 10. It comprises a preferably cup-shaped first part 24 with a first wall arrangement 12 that is stationarily or also adjustably held. This first wall arrangement 12 is mounted in a fluid-tight manner to a dividing wall 14, e.g., by being welded, screwed, pressure-fitted, glued, or the like. The first wall arrangement 12 comprises a bottom 16 that is connected to the wall arrangement 12 in a fluid-tight manner.

The first wall arrangement 12 and the bottom 16 circumscribe an inflow volume 18 that is essentially cylindrical. The bottom 16 preferably extends into the inflow volume 18. It may have a conical shape and comprise flow guiding surfaces 19. The input pressure Pₑ prevails upstream of the dividing wall 14 and in the inflow volume 18. For example, two recesses are arranged in the first wall arrangement 12, these forming a first flow opening 20 and a second flow opening 22.

The first wall arrangement 12 and the bottom 16 belong to the first part 24 of the control actuator 10. Fluid, in particular gas, preferably fuel gas, can move through the first flow opening 20 and the second flow opening 22 out of the first part 24 and the inflow volume 18 into a region 26 where the output pressure Pₐ prevails.

A second part 28 is arranged outside the first part 24. The second part 28 is preferably cup-shaped. The latter comprises a second wall arrangement 30 having a first wall section 32 and a second wall section 34. The second wall arrangement 30 is preferably arranged so as to be concentric to the first wall arrangement 12 and is arranged so as to adjustable parallel to the first wall section 12. The first wall section 32 and the second wall section 34 form a wall section pair 36. The wall sections 32, 34 comprise a first adjustment edge 38 and a second adjustment edge 40. Furthermore, the second part 28 comprises a radial connector 42 that connects the second wall arrangement 30 to a central force introducing site. The radial connector 42 may be configured as a closed or perforated bottom, as a grid, as a wheel spider or the like. The radial connector 42, the second part 28 and the bottom 16 of the first part 24 circumscribe a damping volume V_{D}. A first hole 44 and a second hole 46 are machined in the radial connector 42. One side of a stroke adjustment shaft 48 is in centric contact with the radial connector 42. As a result of this arrangement, only a vertical force is applied to the second part by the stroke adjustment shaft 48 and any undesirable lever forces or friction do not occur.

On its other side of the stroke adjustment shaft 48 is connected to an adjustment membrane 50. This adjustment membrane 50 is preferably circular and its edge is connected to a second dividing wall 52. Below the adjustment membrane 50, there is preferably an aneroid capsule 54 having an internal volume that is delimited by the adjustment membrane 50 on one side. Opposite the adjustment membrane 50, the internal volume is delimited by an aneroid capsule bottom 56. The delimited volume may be connected via an inlet to a line for the targeted pressure application to the adjustment membrane 50. Alternatively, the inlet may remain open. This may be the case, in particular, when a spring 60 acting on the adjustment membrane 50 is provided, said spring acting with a defined, optionally adjustable, force on the adjustment membrane 50 and thus on the stroke adjustment shaft 48. The end of the spring 60 distal to the adjustment membrane 50 abuts against an adjustable fitting that comprises an adjustment dial 58. Said fitting is non-torsionally connected to a threaded element that is seated in a threaded bore of the aneroid capsule bottom 56.

By rotating the adjustment dial 58 the spring 60 can be biased and thus the spring force acting on the adjustment membrane 50 adjusted. Additionally, referring to the illustrated membrane position, the pressure P_{Stell} prevails in the internal volume of the aneroid capsule 54.

The fluid flows into the inflow volume 18, preferably along a basic inflow direction Sₑ. This basic inflow direction Sₑ is broken on the (optional) flow guide surfaces 19 of the bottom 16, and, as a result of this, the fluid flow is directed essentially radially in preferred outflow directions Sₐ against the second wall arrangement 30 arranged transversely to the preferred outflow direction Sₐ.

With the flow openings 20, 22 not closed or partially closed, fluid (e.g., gas) may flow—due to a pressure difference between the input pressure Pₑ and the output pressure Pₐ—into the inflow volume 18 and move through a second flow through cross-section 64 of the second flow openings 22 into the region 26. The area and shape of the first and second flow through cross-sections 62, 64 are defined by the flow openings 20, 22, by the form of the wall sections 33, 34 of the second wall, by the form of the adjustment edges 38, 40, and by the adjustment height h of the adjustment edges. In particular, it is possible to adapt these features to each other in such a manner that a linear connection results between the adjustment path and the flow resistance.

Due to a pressure difference between the pressures Pₑ and Pₐ, a first force F₁ and a second force F₂ act on the first delimiting part 66 of the first wall section 32 and the second delimiting part 68 of the second wall section 34, these partially covering the flow openings. The first and the second wall arrangements 12 are designed so as to be symmetrical relative to plane E, and the forces F₁ and F₂ are equal in value and extend in opposite direction. They negate each other in the center of the control actuator 10. Therefore, the force acting on the second part 28 of the control actuator 10 is constant and independent of the input pressure Pₑ. Also, an input-side pressure surge does not directly lead to an undesirable adjustment at undesirable locations of the second part 28, because the forces resulting from the pressure surge contact the second part only on the circumference on parts of the wall sections 32, 34 that at least partially cover the flow openings 20, 22 and then negate each other in the center of the control actuator 10.

Ultimately, the output pressure Pₐ is to be adjusted to a value corresponding to a set pressure. In the exemplary embodiment, the set pressure can be adjusted and prespecified by the total force F_{R} of the spring 60 and by the force of the adjustment membrane 50 based on the force P_{Stell}. The adjustment membrane 50 assumes a position such that a force equilibrium prevails between the force Pₐ caused by the pressure on the adjustment membrane 50 and the resultant force F_{R}. Via the stroke adjustment shaft 48, the adjustment membrane 50 adjusts the second part 28 parallel to the first part 24. In so doing, the adjustment height h is adjusted and thus the size of the flow cross-section through the flow openings. The adjustment height h is a function of the pressure Pₐ and—via the profile of the size of the flow cross-sectional area over the adjustment height h—it is possible to influence the adjustment height h as a function of the pressure. For example, in this manner, a linear, progressive or digressive function profile can be achieved and, for example, the influence of the force/path characteristic of the spring 60 can be equalized.

In one embodiment, the damping volume VD is increased or decreased during an adjustment movement of the second part 28. As a result of this, fluid must flow toward or away from the first hole 44 and the second hole 46. The diameters of the holes 44, 46 are selected such that the flow resistance of the holes 44, 46 cushions an adjustment movement of the control actuator 10. In this manner it is possible, for example, to reduce the influence of rapid periodic fluctuations of use, said fluctuations potentially being caused, e.g., by the output side, e.g., by the gas user, and potentially lead to unnecessary adjustment movements. If a pressure shock occurs, for example, on the input pressure side, the increased pressure spreads into the region 26. This pressure has an active surface on the radial connector 42, on one side, and on the adjustment membrane 50, on the other side. The active surfaces are different from each other only due to the opening areas of the first hole 44 and the second hole 46. The forces acting on the radial connector 42 and the adjustment membrane 50 are thus approximately equal and inverse. The effect, e.g. in the form of an undesirable adjustment of the second part, is considerably reduced by this arrangement.

In another embodiment the diameter of the first hole 44 and of the second hole 46 is selected to be relatively large, and, for example, several large holes are provided in the radial connector 42, or the radial connector 42 is configured as a spider wheel. Overall, the radial connector 42 in accordance with this embodiment is designed in such a manner that it provides an only minimal flow resistance, preferably no flow resistance. In this exemplary embodiment, the effect due to a pressure surge or a sudden increase of the input pressure directly on the radial connector 42 is negligible, and the pressure acts directly on the adjustment membrane 50 and can lead to an instant adjustment movement of the second part 28. Preferably, the spring 60 or an alternative force element, for example a weight, exhibits a flat force/path characteristic. Even a minimal pressure difference between the actual pressure and the set pressure leads to a large adjustment movement of the adjustment membrane 60 with the use of such a soft force element.

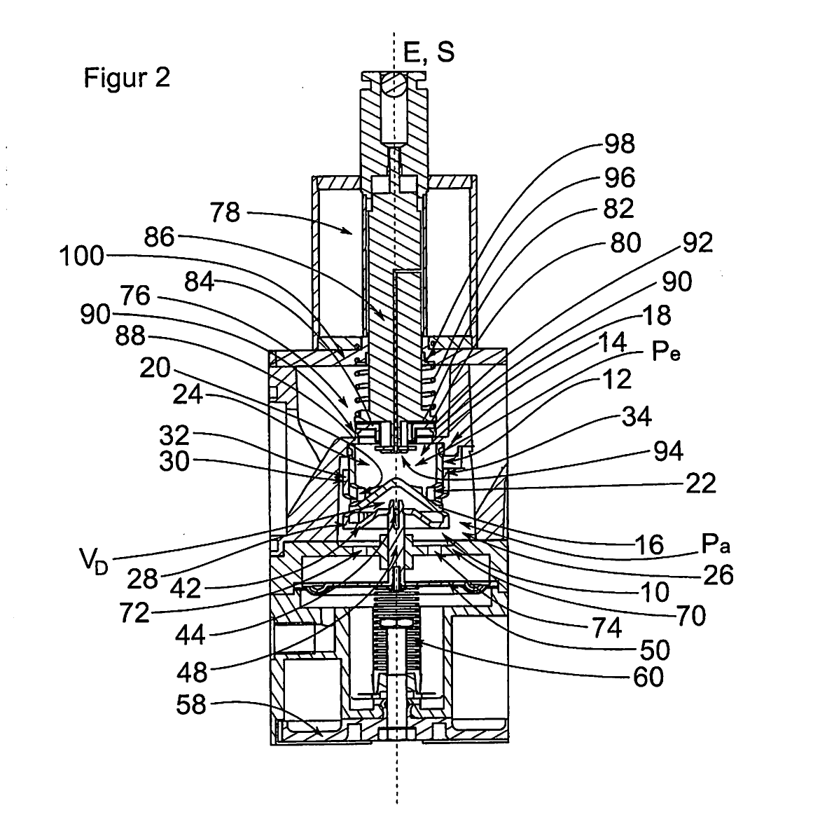

FIG. 2 shows another exemplary embodiment of a control actuator 10. The first part and the second part are configured so as to be essentially rotation-symmetrical relative to an axis of symmetry S. The first wall arrangement 12 of the first part 24 has four recesses that have a first discontinuous flow opening 20 and a second discontinuous flow opening 22. The second part comprises a radial connector 42 which is configured as a closed bottom, for example, the center of which has a first hole 44. On the one hand, fluid may pass from the damping volume into the region 26 outside the second part and, on the other hand, a stroke adjustment shaft 48 is located in the first hole 44. In addition, the control actuator 10 has a third dividing wall 70 located between the second part 28 and the adjustment membrane 50. This third dividing wall 70 has a third hole 72 and a fourth hole 74 through which fluid may flow.

By providing a third dividing wall, the adjustment membrane 50 is flow-protected, and direct influences of a fluid flow on the adjustment membrane 50 are at least partially reduced. As a result of this, it is prevented, for example, that the second part 28 performs a continuous periodic adjustment movement when a periodically operating gas engine is fed.

In addition, the control actuator 10 comprises a closing valve arrangement 76 that can be actuated by a magnetic actuator 78. The closing valve arrangement 76 is essentially arranged so as to be rotation-symmetrical to the axis of symmetry S above the first part 24 and the second part 28. The closing valve arrangement 76 comprises a first valve seat 80 that is arranged on an intermediate part 84. The first valve seat 80 is provided with a first seal 82. A first closure part 86 is provided with a first seal 82. A first closure part 86 is seated—at least in closed state of the closing valve arrangement 76—on the first seal 82 of the first valve seat 80. The first valve seat 80 and the first closure part 86 are parts of a first closure valve 87 of the closing valve arrangement. A second valve seat 86 is arranged on the dividing wall 14 and comprises a second seal 90. A second closure part 92 comprises essentially the parts of the underside of the intermediate part 84. The second valve seat 86 and the second closure part 92 are parts of a second closing valve 93. A lock washer 94 is provided on the first closure part 86 that partially projects into the inflow volume 18. A resetting spring 96 is radially arranged around the first closure part 86. The resetting spring 96 may exert a force on the first closure part 86, on the one hand, and exert a force on the sealing ring 98 arranged on a lid wall 100, on the other hand. An equalizing channel 96 is machined into the first closure part 86, said channel establishing a fluid connection from the inflow volume 18 to the equalizing volume V_{A}.

If the closed closing valve arrangement 76 is opened with the aid of the magnetic actuator 78, the first closure part 86 is first moved against the force of the resetting spring 96 and also against a pressure difference force. In doing so, the intermediate part 84 remains essentially in its place. By lifting the first closure part 86, the seat connection of the first closure part 86 on the first seal 82 of the first valve seat 80 is released, and fluid can flow between the first valve seat 80 and the first closure part 86 into the inflow volume 18. As a result of this, a first pressure equalization can occur. If the first closure part 86 is moved further, it—with the aid of the lock washer 94—lifts the intermediate part 84, and the seat connection of the second closure part 92 on the second seal 90 of the second valve seat 88 is released, so that the fluid can also flow into the inflow volume 18 between the second valve seat 88 and the second closure part 92.

The control actuator 10 in accordance with the invention comprises a first part 24 with a first wall arrangement 12 and a bottom 16 that circumscribe an inflow volume 18. The first wall arrangement 12 comprises at least one flow opening 22, 23 through which fluid from the inflow volume 18 can flow. Furthermore, the control actuator 10 comprises a second part 28 with a second wall arrangement 30 that is arranged so as to be adjustable along the first wall arrangement 12. As a result of this, the fluid flow through a flow opening 22, 23 can be gradually cleared or limited. Preferably, the bottom 16 is arranged in such a manner that the bottom 16 breaks a basic inflow direction Sₑ into the inflow volume 18 and shields the second part 28 against inflow pressure surges. Preferably, the second wall arrangement 30 comprises at least one pair of wall sections 32, 34 that, preferably, are arranged opposite each other so that the forces on the wall sections 32, 34 negate each another in the center of the second part 28.

### LIST OF REFERENCE SIGNS

10 Control actuator
12 First wall arrangement
14 Dividing wall
16 Bottom
18 Inflow volume
19 Flow guiding surfaces
20 First flow opening
22 Second flow opening
24 First part
26 Region
28 Second part
30 Second wall arrangement
32 First wall section
34 Second wall section
36 Wall section pair
38 First adjustment edge
40 Second adjustment edge
42 Radial connector
44 First hole
46 Second hole
48 Stroke adjustment shaft
50 Adjustment membrane
52 Second dividing wall
54 Aneroid capsule
56 Aneroid capsule bottom
58 Adjustment dial
60 Spring
62 First flow cross-section
64 Second flow cross-section
66 First delimiting part
68 Second delimiting part
70 Third dividing wall
72 Third hole
74 Fourth hole
76 Closing valve arrangement
78 Magnetic actuator
80 First valve seat
82 First seal
84 Intermediate part
86 First closure part
87 First closure valve
88 Second valve seat
90 Second seal
92 Second closure part
93 Second closure valve
94 Lock washer
96 Resetting spring
98 Sealing ring
Lid Cover wall
A₁ First surface vector
A₂ Second surface vector
E Plane of symmetry
F₁ First force
F₂ Second force
F_{R} Total force
h Adjustment height
Pₑ Input pressure
Pₐ Output pressure
P_{Stell} Pressure in the aneroid capsule
R Adjustment direction
S Axis of symmetry
Sₑ Basic inflow direction
Sₐ Preferred outflow direction
V_{D} Damping volume
V_{A} Equalizing volume

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. Control actuator (10), comprising
a first part (24) with a closed bottom (16) as well as a first wall arrangement (12) having at least one flow opening (20, 22), wherein the bottom (16) and the wall arrangement (12) delimit an inflow volume (18),
a second part (28) arranged outside the inflow volume (18) and a second wall arrangement (30) with at least two wall sections (32, 34), wherein the wall arrangement (30) is arranged so as to be adjustable along the first wall arrangement (12) in an adjustment direction in order to gradually clear or close the flow opening (20, 22) by means of the wall sections (32, 34), and
an adjustment drive (50) that is connected to the second part (28) in order to move said second part in the adjustment direction (R).

2. Control actuator (10) as in claim 1,
characterized in that, respectively two wall sections (32, 34) of the second part (28) are connected to each other and form a wall section pair (36), wherein the wall sections (32, 34) of a wall section pair (36) exhibit surface vectors (A₁, A₂) pointing in opposite directions.

3. Control actuator (10) as in claim 1,
characterized in that the wall sections (32, 34) of a wall section pair (36) are arranged in such a manner that the wall sections (32, 34) of the wall section pair (36) are arranged so as to be surface-symmetrical with respect to each other relative to a first plane (E).

4. Control actuator (10) as in one claim 1,
comprising the first part (24) with the wall arrangement (12) having the basic form of a hollow cylinder.

5. Control actuator (10) as in claim 1,
characterized in that the bottom (16) of the first part (24) projects into the inflow volume (18) in order to divide one inflow into at least two partial flows of different directions.

6. Control actuator (10) as in claim 1,
characterized in that the bottom (16) comprises at least one flow guiding surface (19).

7. Control actuator (10) as in claim 1,
characterized in that the wall sections (32, 34) of the second wall arrangement (30) are oriented so as to be perpendicular to a preferred outflow direction (Sₐ).

8. Control actuator (10) as in claim 1,
characterized in that the second part (28) comprises a radial connector (42) that connects the second wall arrangement (30) to a central force introducing site.

9. Control actuator (10) as in claim 8,
further comprising a first hole 44 and a second hole 46 machined into the radial connector (42).

10. Control actuator (10) as in claim 9,
further comprising a stroke adjustment shaft (48) in centric contact with the radial connector (42).

11. Control actuator (10) as in claim 10,
further comprising an adjustment drive (50) connected to the stroke adjustment shaft (48).

12. Control actuator (10) as in claim 11,
characterized in that the adjustment drive (50) is a membrane adjustment drive.

13. Control actuator (10) as in claim 12,
further comprising an aneroid capsule (54) and an aneroid capsule (56) disposed to prespecify a pressure difference between an input pressure (Pₑ) and an output pressure (Pₐ).

14. Control actuator (10) as in claim 13,
further comprising a spring (60) acting on the adjustment drive (50).

15. Control actuator (10) as in claim 1,
comprising a closing valve arrangement (76) above the first part (24).

16. Control actuator (10) as in claim 15,
characterized in that the closing valve arrangement (76) comprises a first closure valve (87) having a first valve seat (80) and a first valve closure part (86), and a second closure valve (93) having a second valve seat (88) and a second closure part (92), wherein the closing valves (87, 93) are disposed to open or close in sequence.
